(19) United States
(12) Patent Application Publication
(10) Pub. No.: US 2026/0284870 A1
(43) Pub. Date: Sep. 24, 2026

(54) PERFORMING USER TASKS

(71) Applicant: Beijing Youzhuju Network Technology Co., Ltd., Pinggu District, Beijing (CN)

(72) Inventors: Hongtao Wu, Beijing (CN); Tao Kong, Beijing (CN)

(21) Appl. No.: 19/101,400

(22) PCT Filed: Jul. 18, 2024
(86) PCT No.: PCT/CN2024/106250

§ 371 Date: Feb. 5, 2025

(51) Int. Cl. B25J 9/16; G06V 10/70; G10L 13/08

(52) U.S. Cl. CPC B25J 9/16; G06V 10/70; G10L 13/08; G06V 2201/07

(57) ABSTRACT

Methods, apparatuses, devices, and media for performing user tasks are provided. In a method, receiving a user task from a user, the user task instructing a robotic device to obtain a first object; determining a second object associated with the first object; and in response to determining that a first image of a physical space in which the robotic device is located indicates that the first physical space includes the first object and the second object, instructing the robotic device to obtain the first object and the second object. With the example embodiment in the disclosure, the robotic device may perform the user task in a complex physical space, which may improve the flexibility and accuracy of the robotic device performing tasks in complex environments, thereby completing the expected user tasks.

### FIELD

Example embodiments in the disclosure generally relate to the field of robots, and in particular, to a method, an apparatuses, a devices and a computer-readable storage medium for performing user tasks with robots.

### BACKGROUND

Robotic technology has rapidly developed and has been widely used in many technical fields. Various special-purpose robotic devices have been developed. For example, in industrial environments, robots can be used to perform various tasks such as processing, grasping, sorting, packaging, and the like. For another example, in home environments, robotic vacuum cleaners, robotic window cleaners, and the like have been developed. However, robots usually can only execute preset fixed tasks and cannot perform different user tasks according to user requirements.

### SUMMARY

In a first aspect in the disclosure, a method for performing a user task is provided. In the method, receiving a user task from a user, the user task instructing a robotic device to obtain a first object; determining a second object associated with the first object; and in response to determining that a first image of a physical space in which the robotic device is located indicates that the first physical space includes the first object and the second object, instructing the robotic device to obtain the first object and the second object.

In a second aspect in the disclosure, an apparatus for performing a user task is provided. The apparatus includes: a receiving module configured to receive a user task from a user, the user task instructing the robotic device to obtain a first object; a determining module configured to determine a second object associated with the first object; and an obtaining module configured to instruct the robotic device to obtain the first object and the second object in response to determining that a first image of a physical space in which the robotic device is located indicates that the first physical space includes the first object and the second object.

In a third aspect in the disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method according to the first aspect in the disclosure.

In a fourth aspect in the disclosure, there is provided a computer-readable storage medium having stored thereon a computer program which, when executed by a processor, causes the processor to implement the method according to the first aspect in the disclosure.

In a fifth aspect in the disclosure, there is provided a computer program product, including a computer program, where the computer program, when executed by a processor, implements the method according to the first aspect in the disclosure.

It should be understood that the content described in this disclosure is not intended to limit key features or important features of embodiments in the disclosure, nor is it intended to limit the scope of the disclosure. Other features in the disclosure will become readily understood from the following description.

### BRIEF DESCRIPTION OF DRAWINGS

The above and other features, advantages, and aspects of the various embodiments in the disclosure will become more apparent from the following detailed description taken in conjunction with the accompanying drawings. In the drawings, the same or similar reference numbers refer to the same or similar elements, where:

FIG. 1 illustrates a block diagram of an application environment according to an example embodiment in the disclosure;

FIG. 2 illustrates a block diagram for performing a user task according to some embodiments in the disclosure;

FIG. 3 illustrates a block diagram of an image acquisition process according to some embodiments in the disclosure;

FIG. 4 illustrates a block diagram of a process invoking a language model according to some embodiments in the disclosure;

FIG. 5 illustrates a block diagram of a process invoking a language model according to some other embodiments in the disclosure;

FIG. 6 illustrates a block diagram of a process invoking an action model according to some embodiments in the disclosure;

FIG. 7 illustrates a block diagram of a process obtaining an object according to some embodiments in the disclosure;

FIG. 8 illustrates a flowchart of a method for performing a user task according to some embodiments in the disclosure;

FIG. 9 illustrates a block diagram of an apparatus for performing a user task according to some embodiments in the disclosure; and

FIG. 10 illustrates a block diagram of a device in which various embodiments in the disclosure may be implemented.

### DETAILED DESCRIPTION

Embodiments in the disclosure will be described in more detail below with reference to the accompanying drawings. While certain embodiments in the disclosure are shown in the accompanying drawings, it should be understood that the disclosure may be implemented in various forms and should not be construed as limited to the embodiments set forth herein, but rather, these embodiments are provided for a more thorough and complete understanding of the disclosure. It should be understood that the drawings and embodiments in the disclosure are for illustrative purposes only and are not intended to limit the scope of the disclosure.

In the description of embodiments in the disclosure, the terms “include”, and similar terms should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments in the disclosure are used, the types of personal information related to the disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution in the disclosure according to the prompt information.

As an optional but non-limiting embodiment, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on embodiments in the disclosure, and other manners of meeting related laws and regulations may also be applied to embodiments in the disclosure.

The term “responsive to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

In recent years, robotics and machine learning technologies have been widely used in multiple application scenarios. However, robots usually can only perform predetermined fixed tasks and cannot perform different user tasks based on user requirements. In particular, in complex application environments, it is difficult for a robotic device to determine user needs and then perform corresponding tasks.

Currently, simple robotic devices that perform particular tasks have been developed. However, such simple robotic devices do not understand complex user instructions nor perform desired tasks according to user instructions in complex physical spaces. It is desirable to control the operations of a robot in an efficient manner to perform desired tasks.

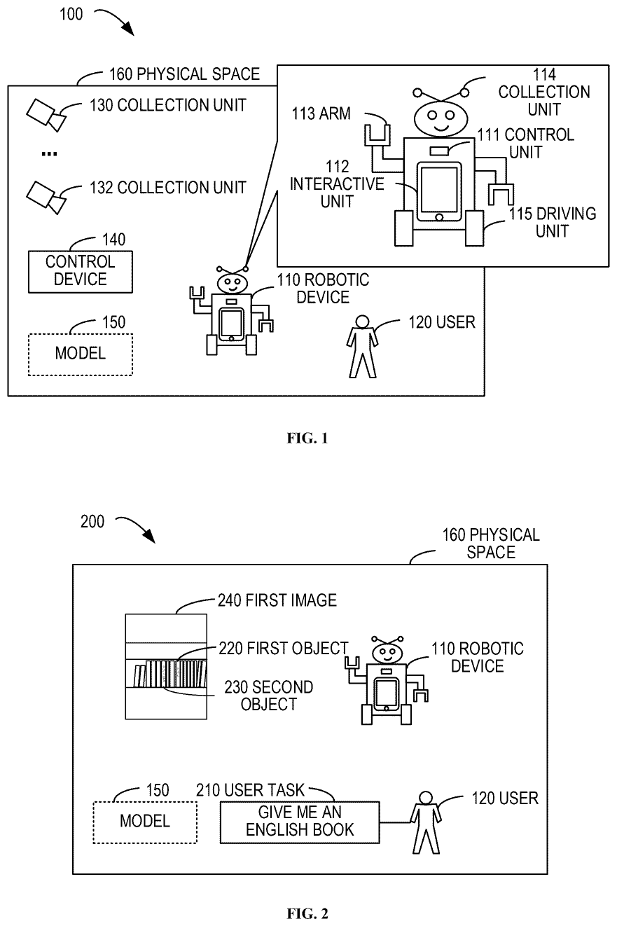

According to an example embodiment in the disclosure, a method for executing a user task is provided. FIG. 1 shows a block diagram 100 of an application environment according to an example embodiment in the disclosure. As shown in FIG. 1, a robotic device 110 and a user 120 may be located in a physical space 160, and the user 120 may control the robotic device 110 to perform a variety of tasks. The physical space 160 may include, but is not limited to, one or more rooms. For example, in a home environment, the physical space 160 may include, but is not limited to, a living room, a bedroom, a study room, and the like, or a combination including one or more of the above. For another example, in a teaching environment, the physical space 160 may include, but is not limited to, a classroom, a laboratory, a library, and the like.

As shown in FIG. 1, the robotic device 110 may include multiple parts. For example, a control unit 111 may serve as a control center of the robotic device 110, and load an application program into the control unit 111, so as to control various parts of the robotic device. The user 120 may use an interactive unit 112 to interact with the robotic device 110, e.g., input control instructions to the robotic device 110, so as to use the robotic device 110 to perform a desired task. The robotic device 110 may include an arm 113 for performing actions such as grasping, releasing, and the like. For example, arm 113 may grasp a certain object and move the object to a desired location, and so on.

Alternatively and/or additionally, the robotic device 110 may also include a collection unit 114. Here, the collection unit 114 may include various types, for example, an image acquisition unit, a sound collection unit, and the like. Alternatively and/or additionally, the robotic device 110 may further include a sensing unit for detecting surrounding objects, for example, detecting a distance between the robotic device and surrounding objects based on laser, and so on. The robotic device 110 may also include a driving unit 115, for example, the robotic device 110 may be deployed over a movable base, and the driving unit 115 may drive wheels of the base to move along a desired path.

The physical space 160 may include one or more collection units 130, . . . , and 132. For example, one or more image acquisition devices may be deployed in a room to capture images of the room from various angles. The physical space 160 may include a control device 140 that may control one or more collection units 130, . . . , and 132, etc., via a network (not shown). Alternatively and/or additionally, in a smart home environment, the control device 140 may control various electrical devices in the physical space 160.

Alternatively and/or additionally, a machine learning model (e.g., model 150) may be provided to manage the physical space 160. It should be understood that although FIG. 1 shows that the model 150 is located within the physical space 160, alternatively and/or additionally, the model 150 may be located at a remote device outside the physical space 160, and the control device 140, the robotic device 110, or other device may access the remote model 150 via a network.

The model 150 may include one or more models. If the model 150 includes a plurality of models, the plurality of models may include a plurality of types of models. The model 150 may include, for example, at least a language model (LM) and an action model. The language model may have question-answering capabilities by learning from a large corpus of corpora. The action model may control the robotic device 110 to perform various actions. The model 150 may also include, for example, an image recognition model, a text recognition model, and the like.

As shown in FIG. 1, the user 120 may instruct the robotic device 110 to operate various objects in the physical space 160. Here, the objects may be various items in a home environment, for example, the user 120 may instruct the robotic device 110 to find a certain object in the physical space 160. For another example, the user 120 may instruct the robotic device 110 to place the found object to a specified location, and so on.

### Summary of Performing a Task

In order to at least partially address the deficiencies in the prior art, according to an example embodiment in the disclosure, a method for executing a user task is provided. Referring to FIG. 2, a summary according to an example embodiment in the disclosure is described, which shows a block diagram 200 for performing a user task according to some embodiments in the disclosure.

As shown in FIG. 2, the robotic device 110 in the physical space 160 (also referred to as the first physical space) may receive a user task 210 from the user 120. At this point, the user task 210 may instruct the robotic device 110 to obtain the first object 220. For example, in the example of FIG. 2, the first object 220 may be an “English book”, and the user 120 may speak “Give me an English book” to the interactive unit 112 in natural language. The speech recognition module built into the robotic device 110 receives and parses this voice command into an executable user task 210.

After receiving the user task 210, the robotic device 110 may directly take the first object 220 to the user 120, or determine a second object 230 (for example, an English exercise book) that is closely related to the first object 220 (for example, the English book) mentioned in the user task 210. In order to understand the task more intelligently, the robotic device 110 may invoke the machine learning model 150 to analyze the historical behavior of the user 120. For example, each time the user 120 picks up an English book, he or she tends to subsequently pick up the English exercise book for practice. The model 150 predicts that the user 120 may wish to obtain both the “English book” and the “English exercise book” based on the historical data, thereby confirming that the English exercise book is the second object.

Alternatively and/or additionally, when the user 120 issues a command to the robotic device 110 to “get an English book”, the interactive unit 112 may capture this voice command. The natural language processing (NLP) algorithm built into the control unit 111 begins to parse the text to understand the meaning of the command. The model 150 may also access an object relational database which may store association information between various items. For example, a high frequency of occurrence between English books and English exercise books may be recorded in the database, indicating their close connection in a usage scenarios. When receiving the command “English book”, the model 150 may query the database and find that as an object that frequently appears together with English books, the English exercise book may be obtained at the same time in this task, and the English exercise book may be determined as the second object 230.

Alternatively and/or additionally, the model 150 may also analyze the names and attributes of the items to determine potential associations. For example, the name “English exercise book” itself implies that it is a learning material associated with “English books”. Through the keywords “English” and “exercise” in the name, the model may recognize that the two objects belong to the same learning domain, thereby determining that there is an association between them.

Next, the control unit 111 of the robotic device 110 may invoke the image acquisition device, such as a camera, in at least any one of the collection units 114, 130, . . . , and 132 to acquire the first image 240 of the physical space 160. For example, the robotic device 110 may scan the first physical space 160 through a camera on its head or body. With the support of the model 150, the robotic device 110 may recognize specific object shapes, colors, and texts from the complex first image 240, thereby accurately locating the locations of the English book and the English exercise book.

In response to determining that the first image 240 of the physical space in which the robotic device 110 is located indicates that the first physical space 160 includes the first object 220 and the second object 230, the robotic device 110 may be instructed to obtain the first object 220 and the second object 230. For example, after determining that the English book and the English exercise book exist in the first image 240, the control unit 111 of the robotic device 110 may plan a travel path to reduce the moving distance and time consumption. The driving unit 115 of the robotic device 110 is then started and moves along the planned path to the vicinity of the English book. After arriving at the destination, the arm 113 of the robotic device 110 extends and grasp the English book using the grasping device at its end. The robotic device 110 then repeats the process described above, goes to the location of the English exercise book and grasp it.

Finally, the robotic device 110 may carry the English book and the English exercise book, move to the location of the user 120, place the first object and the second object on the desk, or deliver the first object 220 and the second object 230 to the user 120. Alternatively and/or additionally, after the action of the robotic device 110 is completed, the user 120 may be reported through the interactive unit 112 that the task has been completed, waiting for a next command.

According to some embodiments in the disclosure, the methods described above may be performed at any computing device with computing capabilities. For example, the methods described above may be performed with an application deployed at the robotic device 110. Alternatively and/or additionally, an application may be deployed at control device 140 to perform the methods described above. Specifically, the powerful processing capabilities of the model 150 may be invoked to determine the second object 230 closely related with the first object 220, and to find the first object 220 and the second object 230 from the first image 240.

With example embodiments in the disclosure, the robotic device may perform user tasks in complex physical spaces. In this manner, the robotic device may intelligently complete the task of obtaining the first object and obtaining the related second object by receiving the user task, analyzing the task, locating the object, planning the path, and executing the action. The robotic device can predict the user's subsequent possible needs in advance, and provide more intelligent and humanized services. In this manner, the flexibility and accuracy of the robotic device in performing tasks in a complex environment can be improved, thereby completing the expected user task.

### Detailed Procedure for Performing a Task

An overview of some embodiments according to the disclosure has been described. In the following, more details with respect to performing user tasks will be described. For ease of description, it is described below more details of performing the user task by only using the control of the robotic device 110 to obtain English books and English exercise books as an example.

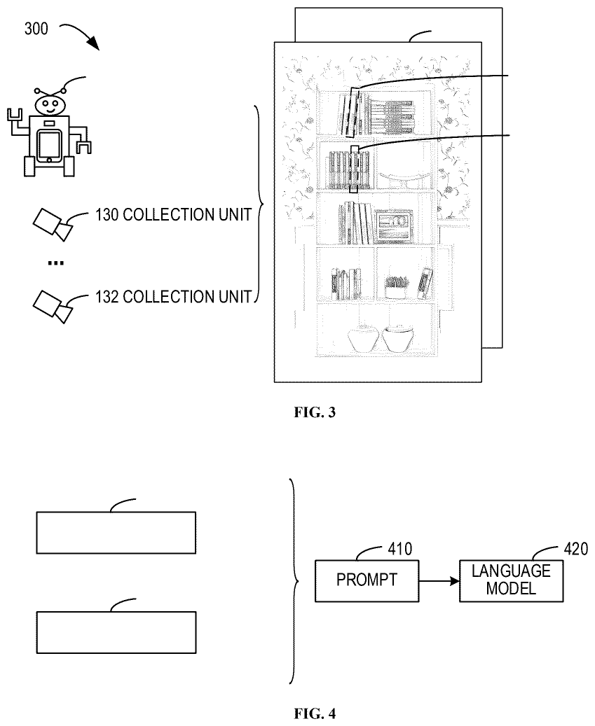

According to some embodiments in the disclosure, the first image may come from at least one of the following: a collection unit at the robotic device 110, and a collection unit in the first physical space. Referring to FIG. 3 for more details of image acquisition, which shows a block diagram 300 of an image acquisition process according to some embodiments in the disclosure. As shown in FIG. 3, a first image (e.g., one or more images 310) of the physical space 160 may be obtained from the collection unit 114 at the robotic device 110. Since the robotic device 110 may move freely in the physical space 160, the collection unit 114 may acquire images of various locations in the physical space, thereby facilitating the search for the target object.

Alternatively and/or additionally, the first image of the physical space 160 may be acquired from the collection units 130, . . . , and 132. Here, the collection units 130, . . . , and 132 may be pre-deployed in a specified location within the physical space 160, e.g., within a study room, etc. In this manner, richer data can be acquired from multiple angles.

According to some embodiments in the disclosure, when determining the second object 230 associated with the first object 220, a first prompt 410 may be obtained based on the user task 210 and the user information 120-1 of the user 120. The first prompt 410 is used to determine the second object 230. Next, the robotic device 110 may receive a first response of the machine learning model 150 for the first prompt 410 to determine the second object 230. The prompt may, for example, be expressed as: “Please determine another book closely related to the ‘English book’, and the prompt 410 is submitted to the model 150.

As shown in FIG. 4, when the user 120 issues a user task 210 of “Give me an English book” through the interactive unit 112, the control unit 111 of the robotic device 110 may parse the literal meaning of the user task 210, that is, locate and obtain the English book. Meanwhile, the robotic device 110 may also invoke a user information database to analyze the historical behaviors, interests and usage habits of the user 120. For example, the database records that when the user 120 learns English, there is a high probability (for example, a preset probability threshold) that the user 120 may use an English book and an English exercise book at the same time. Based on the user task 210 (e.g., give me an English book) and the user information 120-1 (e.g., Seventh grade—Alice), the robotic device 110 may obtain the first prompt 410. “English book” is used as the core word, plus the highly correlated “English exercise book” obtained from the user behavior analysis, constitute the first prompt 410. The prompt 410 not only includes the information directly instructed by the user task 210, but also implies the possible subsequent needs of the user 120.

Next, the robotic device 110 sends the first prompt 410 to the machine learning model (e.g., the language learning model 420), requesting the language model 420 to make a first response based on the first prompt 410. After receiving the first prompt 410, the language model 420 returns a response (that is, the first response) through analysis and reasoning, and determines that “English exercise book” and “English book” have a strong correlation in the current context and should be regarded as the second object 230. The robotic device 110 receives and parses the first response of the language model 420, determining that the “English exercise book” is the second object 230 associated with the “English book” in the user task 210.

With some embodiments in the disclosure, the robotic device 110 may provide the capability to handle complex tasks by acquiring and analyzing prompts and interacting with the language model 420. The second object 230 is further determined based on the user information 120-1 and the user task 210, thereby enhancing the capability of the robotic device 110 performing tasks in a complex environment, and also providing the user 120 with a more considerate and efficient service.

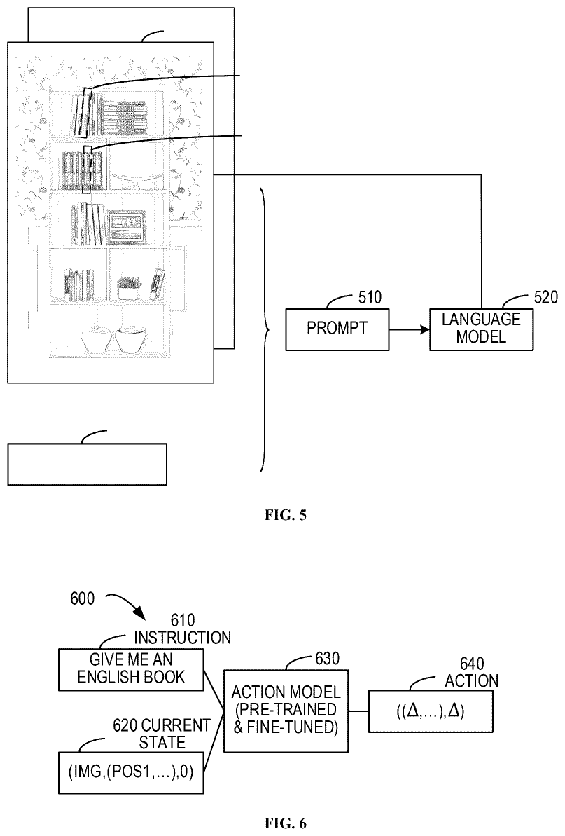

According to some embodiments in the disclosure, the first prompt may further be obtained based on the first image. As shown in FIG. 5, when the robotic device 110 receives the user task 210 “Give me an English book”, the robotic device 110 first moves to the study room, and uses the collection unit 114 to capture the first image 310 of the physical space 160, for example, using a camera or a visual sensor. Alternatively and/or additionally, the robotic device 110 or its connected image processing module may preprocess the first image 310, including adjusting brightness, contrast, etc., to improve image quality. Next, various objects in the first image 310 are identified by a target detection algorithm, including but not limited to English books.

After determining the location of the English book, the robotic device 110 may further construct a first prompt 510, for example, “Please identify an object associated with the English book in the following images”. Here, the first prompt 510 not only includes a text description but also includes a description of the first image, which may guide the model 520 to identify other objects in the image that are closely related to the English book.

Next, the robotic device 110 sends the first image 310 and the first prompt 510 to the model 520, requesting the language model 520 to analyze the second object 230 related to the English book in the image. After receiving the first prompt 510, the model 520 analyzes the first image 310 using its deep learning algorithm and identifies items with a high degree of association with English books, for example, English exercise books. The model then returns an response, confirming that the “English exercise book” is the second object 230. Finally, the robotic device 110 confirms that the English exercise book is the second object 230 based on the response of the model 520.

With some embodiments in the disclosure, the robotic device 110 may construct the first prompt 510 using the image information and determine a second object associated with the first object, which helps improve the task understanding and execution capability of the robotic device 110.

According to some embodiments in the disclosure, in response to the first image indicating that the physical space includes a plurality of second objects associated with the first object, the second object may be selected from the plurality of second objects. For example, there may be a plurality of other objects associated with the first object (e.g., the English book) in the first image, such as an English exercise book, an English notebook, a vocabulary book, or the like.

After determining that there are a plurality of second objects, the robotic device 110 needs to further determine which second objects are most relevant or most likely to be needed by the user 120. In some embodiments, the robotic device 110 may determine a particular second object based on the user interest. For example, if the user's historical behavior indicates that an English exercise book tends to be used at the same time when an English book is obtained, then the robotic device 110 will preferentially select the English exercise book as the second object. In other embodiments, by analyzing the relative locations and states of various objects in the first image, the robotic device 110 may infer which second objects are most likely to be used together with the English book. For example, the second object closest to the first object may have been used together.

Alternatively and/or additionally, the first image and the user information 120-1 may also be analyzed using a machine learning model to predict possible subsequent needs of the user 120, thereby making an optimal selection. For example, if the user is a primary school student, English books and exercise books for the primary school stage may be provided to the user first. For another example, if the user is a middle school student, if the user is a middle school student, English books and exercise books for the middle school stage may be provided to the user first.

With some embodiments in the disclosure, the robotic device may not only identify a plurality of second objects in the physical space 160 that are associated with the first object, but also select, from the plurality of second objects, the second object that best meets the user requirement, which helps improve efficiency and accuracy of the robotic device 110 performing tasks.

According to some embodiments in the disclosure, in response to determining that the first image of the physical space 160 indicates that the first physical space includes the first object but not the second object, the robotic device may be instructed to obtain the first object. For example, by analyzing the first image, the robotic device 110 may recognize that the first object (e.g., the English book) exists in the physical space 160, but does not detect the presence of the second object (e.g., the English exercise book). In this case, the robotic device 110 may be instructed to perform the initial task, that is, only obtain the first object (the English book).

In this manner, when the robotic device 110 confirms that the first object exists and the second object does not exist, the robotic device 110 will directly focus on obtaining the first object without performing an additional search for the second object, which can enable the robotic device 110 to accurately perform the user task 210 and effectively utilize resources.

According to some embodiments in the disclosure, when determining that the first image of the physical space 160 indicates that the first physical space includes the first object but not the second object, a message may be further provided to the user 120, and the message is used to inquire the user 120 for the location of the second object in the physical space 160. Next, in response to receiving a response from the user 120 to the message, the robotic device 110 may be instructed to obtained the second object based on the response.

For example, the robotic device 110 confirms the presence of the first object (e.g., the English book) by analyzing the first image in the physical space 160 but fails to identify the second object (e.g., the English exercise book) associated the first object in the image. The robotic device 110 may further interact with the user 120 intelligently, supplementing the lack of environmental perception via the response of the user 120.

Next, after receiving the message, the user 120 may provide information about the location of the second object. For example, the response to the message from the user 120 is “English exercise book is on the table in the study room”. Here, the response of the user 120 includes key information needed by the robotic device 110 to complete the task. After receiving and parsing the response of the user 120, the robotic device 110 may incorporate the new information into its task planning and replan the path to find and obtain the second object, for example, the English exercise book.

With some embodiments in the disclosure, the robotic device 110 may dynamically adjust its capability to perform tasks based on feedback of the user 120 in performing tasks.

According to some embodiments in the disclosure, the user 120 may also control the robotic device 110 to read a text to help the user 120 read. For example, if the first object is a book, the user 120 may send a request to the robotic device 110 to request the robotic device 110 to convert the text information in the book into a voice form. In some embodiments, the request sent by the user 120 may be completed through voice commands, touchscreen operations, or any other user interface.

Next, after receiving the request from the user 120, the robotic device 110 begins to recognize the text content in the book. For example, the robotic device 110 scans the book page and converts the printed text into a digital text format through optical character recognition technology, thereby forming the first text data. The robotic device 110 then converts the first text data to first audio data. For example, the robotic device 110 may synthesize the text information into human-recognizable speech through text-to-speech (TTS) technology, so that the user 120 can hear the content of the book without directly reading the book.

With some embodiments in the disclosure, the robotic device 110 may complete the conversion from the book text to the voice output after receiving the command from the user 120. This may provide a way for a visually impaired user 120 to obtain written information, and may also enable busy users or users who prefer to listen to books to obtain book content while doing other things, thereby expanding the access methods and usage scenarios of book content.

According to some embodiments in the disclosure, when the robotic device 110 is required to convert the text information in the book into a voice form, the robotic device 110 may also be required to convert the text data in a specific position in the book into audio data. For example, the user 120 may issue a specific request to the robotic device 110, which determines the position of the first text data in the book based on the request. Next, the first text data at the corresponding position is converted into the first audio data. Here, the first text data at the corresponding position may be, for example, a specific chapter, paragraph, page, or even a few lines of words. The user 120 may issue the request via voice command, touch screen input, or other interaction methods, and the request may include the title of the book, the name of the author, page number, chapter title or keyword, etc.

Next, after receiving the request from the user 120, the robotic device 110 converts the text data at the corresponding position into voice output. In this manner, the application prospects of the robotic device 110 in the fields of reading assistance, information acquisition and entertainment can be improved, and a more convenient, efficient and personalized reading experience can be provided for users 120 with different requirements.

According to some embodiments in the disclosure, the robotic device 110 may further assist the user 120 in reviewing content in the second object to improve the learning efficiency of the user 120. For example, the robotic device 110 may determine, in the second object, second text data associated with the first text data. Next, second text data is provided to the user 120.

As an example, in a process in which the robotic device 110 assists the user 120 in reading the first text data, the robotic device 110 may further play its auxiliary role by reviewing the content in the object to supplement and deepen the learning experience of the user 120. For example, the robotic device 110 utilizes its information retrieval and analysis capabilities to find second the text data associated with the first text data from the second object. Next, the robotic device 110 may present the second text data to the user 120, for example, through voice reading, screen display, or other suitable output methods.

With some embodiments in the disclosure, the robotic device 110 may not only increase the depth and breadth of the learning of the user 120, but also improve the learning efficiency of the user 120. The user 120 does not need to interrupt the reading to search for relevant data on his/her own, thereby improving the concentration of learning knowledge.

According to some embodiments in the disclosure, the second text data may be, for example, an exercise for a portion of a chapter, and the user 120 may practice on the exercise. For example, when the user 120 is studying a certain topic or chapter, the robotic device 110 may provide a series of exercises associated with the current learning content, which may help the user 120 consolidate and test the understanding and mastery of the knowledge learned.

After the user 120 completes the exercise and submits the answer, the robotic device 110 analyzes the received answer, for example, checks the correctness and completeness of the answer and the rationality of the solution. The robotic device 110 may evaluate each answer submitted by the user 120, for example, to determine whether the answer is right or wrong, and the like.

With some embodiments in the disclosure, the robotic device 110 may help the user 120 to instantly check the learning result by providing exercises closely related to the learning content, while the automatic grading function ensures that the user 120 can obtain timely and accurate feedback, thereby promoting the improvement of learning effects and self-correction.

According to some embodiments in the disclosure, an action model may be used to determine a specific action performed by the robotic device. More details are described with reference to FIG. 6, which illustrates a block diagram 600 of a process invoking an action model according to some embodiments in the disclosure. As shown in FIG. 6, an action model 630 may be provided, which may determine a specific action to be performed by the robotic device based on the current state and instructions of the robotic device, and the action model may be a pre-trained and fine-tuned model.

It should be understood that the current state may include data from a plurality of aspects, such as an image of the robotic device, an image of the environment of the robotic device, posture data of the robotic arm (e.g., positions (POS1, . . . ) of respective joints of the robotic arm), and a state of the tool (e.g., a clamp, a knife, etc.) secured at an end of the robotic arm. For example, 0 may be used to represent the closed state of the clamp and 1 to represent the open state of the clamp. The instruction and the current state may be input to the action model 630, and then the action model is used to determine an action to be performed by the robotic device based on the instruction and the current state. Here, the action may represent the difference between the current posture and the next posture of the robotic device, and the difference between the current state and the next state of the tool, and so on.

The instructions 610 (e.g., “Get an English book”) may be input to the action model 630, where the instructions 610 may be expressed in natural language, and the instructions 610 may be determined from a response of the language model. Further, a current state of the robotic device may be obtained, and the action model 630 may determine a corresponding action 640 based on the input data. For example, the orientation, position, speed, acceleration, etc. of the respective joints in the arm and/or the and/or other movable devices wheels of the robotic device at the next time instance may be determined. Further, the determined action 640 may be utilized to control the state of the robotic device at the next time instance.

With some embodiments in the disclosure, an association relationship may be established between the language model and the action model, and a user task expressed in natural language initially input by the user is converted into a specific action that can be performed by the robotic device. In this manner, the action of the robotic device can be accurately controlled, thereby performing the user task with higher efficiency.

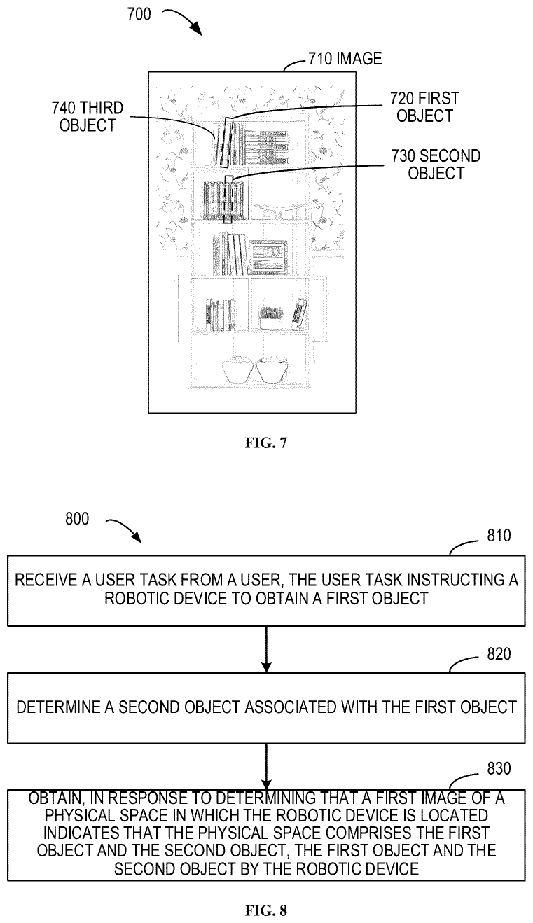

According to some embodiments in the disclosure, if the first object is blocked by other objects, the objects may be removed first, and then the first object may be taken out. Specifically, in response to determining that the first image indicates that the first object is blocked by a third object in the first physical space, the third object may be moved to obtain the first object. Further details are described with reference to FIG. 7, which illustrates a block diagram 700 of a process moving an object according to some embodiments in the disclosure. As shown in FIG. 7, in the image 710, the first object 720 is an English book to be retrieved, and the third object 740 is located on the left side of the first object 720 and blocks the first object 720. At this point, the robotic device 110 may be instructed to move the third object 740 from the current location to a location that does not hinder the retrieval of the first object 720.

According to some embodiments in the disclosure, a target location may be determined, and the robotic device is instructed to move the third object 740 to the target location. At this point, the action model will generate an action to control the robotic device to move the third object 740 from the current location to the target location. In this manner, the robotic device can be supported to process complex problems in a complex environment, thereby performing the user task in a more accurate manner.

According to some embodiments in the disclosure, in the process of moving the third object, a constraint condition during the movement of the third object may be determined based on the posture of the third object, and the robotic device is instructed to move the third object under the constraint condition. In this manner, it can be ensured that each action of the robotic device in the complex environment complies with safety regulations.

According to some embodiments in the disclosure, a manner for arranging a bookcase may also be determined, and the robot device 110 may be instructed to arrange the remaining objects in the bookcase according to the above-mentioned arrangement manner. Specifically, after the robotic device has retrieved the first object 720, a new image may be acquired, and a new prompt may be constructed to inquire the language model for the next instruction. For example, the prompt may be expressed as: “Please determine the next instruction based on the following image”, “What to do next”, and so on. The language model may return “Place the remaining books in order”, and at this point, based on the instruction “Place the remaining books in order” and the current state of the robot device, a corresponding action may be generated to instruct the robot device to put the remaining books in order.

According to some embodiments in the disclosure, after the robotic device 110 finishes arranging the remaining books, the robotic device 110 may be instructed to obtain the first object and the second object, and go to the location where the user 120 is located. Specifically, the image may be acquired in real time, and the user's location in the image may be determined. Further, a corresponding instruction may be determined based on the current location (e.g., location A) of the robotic device and the user location (e.g., location B). At this point, the instruction may be expressed as: Move from location A to location B. At this point, the action model 630 will generate a corresponding action that can control the robotic device 110 to move from location A to location B in accordance with the determined trajectory. In this manner, the robotic device 110 completes the task of “Give me an English book”.

It should be understood that although an example embodiment according to the disclosure is described above in the language environment as an example. Alternatively and/or additionally, according to an example embodiment in the disclosure, the solution may be performed in a plurality of language environments. For example, the robot may be controlled in an environment such as Chinese, English, Japanese, French. Specifically, the robot may be controlled in different languages based on the multi-language capabilities provided by the machine learning technology. Further, although the process of using the robotic device to perform a user task is described above in terms of obtaining an English book and an English exercise book, alternatively and/or additionally, the robotic device may be controlled to perform other user tasks, such as finding other objects in the room, placing an object to a specified location, and/or the like.

According to some embodiments in the disclosure, a user may interact with the robotic device via languages, actions, gestures, or the like. For example, a user may speak a desired user task, predefine an action to specify a user task, and/or the like. When the action is recognized from the captured image sequence, the robotic device may automatically ask whether the user needs to obtain the learning materials, and in the case of a positive response, the robotic device may retrieve the learning materials.

Alternatively and/or additionally, the user may interact with the robotic device via the interactive unit 112, e.g., the user inputs a task represented by text and/or images, and controls the robotic device to perform the task. Alternatively and/or additionally, the user may specify an execution condition of the task, e.g., to perform the task immediately, to perform the task after a predetermined time, or to perform the task if it is determined that a predetermined condition is satisfied (e.g., after the user finishes school), and/or the like.

According to some embodiments in the disclosure, the robotic device may provide a variety of messages to the user. For example, assuming that the robotic device finds multiple types of English books, the user may be asked which type the user needs. For another example, assuming that the robotic device does not find an English book and only finds a mathematics book, the robotic device may ask the user whether a mathematical book is needed, and so on. Alternatively and/or additionally, the robotic device may ask the user where the desired object can be found and go to a location specified by the user to find the desired object. Alternatively and/or additionally, if a desired object cannot be found, the robotic device may ask the user if a purchase is needed, and so on.

According to some embodiments in the disclosure, a variety of positioning algorithms may be utilized to determine the location of the robotic device and the individual objects in the physical space. For example, a global positioning system (GPS) module may be deployed at the robotic device and satellite signals may be used to determine the precise location of the robotic device. Alternatively and/or additionally, a communication unit may be deployed at the robotic device, signals between the communication unit and the base station, and the communication network may be utilized to determine the location of the robotic device. Alternatively and/or additionally, a Wi-Fi access point may be deployed in the physical space, the communication unit at the robotic device may interact with a Wi-Fi access point to determine a location via Wi-Fi signal strength and the location of a known Wi-Fi access point. Alternatively and/or additionally, the communication unit at the robotic device may support Bluetooth functionality, Bluetooth signals and locations of known Bluetooth devices may be used to determine the location of nearby devices. An inertial navigation system may be deployed at the robotic device, and accelerometers and gyroscopes may be used to measure and compute the movement and direction of the device in the space, thereby determining the location of the robotic device.

Alternatively and/or additionally, a visual positioning system may be used to determine the location of the robotic device and/or individual objects. The map of the physical space may be acquired in advance, and the location of each object is marked in the map. The robotic device may utilize an echo detection unit to detect the distance to surrounding objects and determine a specific location of each object in combination with the acquired image and the map of the physical space. Specifically, computer aided design (CAD) and geographic information systems (GIS) may be used, and location algorithms may be utilized to determine the location. Alternatively and/or additionally, a tracking unit may be deployed at an important object in the physical space, for example, the tracking unit may be added to a remote control (for example, a TV remote control, an air conditioner remote control) of a household appliance, so that the robotic device may acquire the precise location of the important object in a timely manner, and so on.

According to some embodiments in the disclosure, the original location of the robotic device and the intended destination may be determined based on the methods described above. The robotic device may determine a path from the original location to the destination. For example, images of the surrounding environment may be continuously acquired, and the path may be continuously updated while ensuring that obstacles are avoided, and the robot device may be moved along the path to the destination.

According to some embodiments in the disclosure, after reaching the destination, the robotic device may perform the specified task. For example, a specified object may be acquired and moved to a respective location. A language model and/or knowledge base may be utilized to determine constraints, i.e., constraints that should be followed during the execution of the task. For example, an image and a corresponding prompt may be acquired, and then input to the language model. Then a constraint condition is received from the language model. For example, a prompt may be determined: “Based on the following images, please determine the constraints that should be followed when moving the XXX object”, or “Please determine the precautions when moving the XXX object”, etc.

At this point, it may be determined that during the movement of an object (e.g., a bottle of water, a plate, a bowl, etc.), the original posture of the object should be maintained (e.g., maintained in a vertical direction and not tilted). Further, constraints may be input to the action model, and at this point, a series of actions output by the action model will perform corresponding tasks while ensuring the constraints. With some embodiments in the disclosure, the safety of the robot device during operation can be ensured, thereby avoiding accidental damage to the object, etc.

With example embodiments in the disclosure, the robotic device may perform user tasks in complex physical spaces. In this manner, the robotic device may intelligently complete the task of obtaining the first object and the associated second object by receiving the user task, analyzing the task, locating the object, planning the path, and executing the action. The robotic device can predict the user's subsequent possible needs in advance, and provide more intelligent and humanized services. In this manner, the flexibility and accuracy of the robotic device in performing tasks in complex environments can be improved, thereby completing the expected user tasks.

### Example Processes

FIG. 8 illustrates a flowchart of a method 800 for performing a user task according to some embodiments in the disclosure. At block 810, receiving a user task from a user, the user task instructing the robotic device to obtain a first object. At block 820, determining a second object associated with the first object. At block 830, in response to determining that a first image of a physical space in which the robotic device is located indicates that the first physical space includes the first object and the second object, the robotic device obtains the first object and the second object.

According to some embodiments in the disclosure, determining the second object includes: obtaining a first prompt based on the user task and the user information of the user, where the first prompt is configured to determine the second object; and receiving a first response of a machine learning model for the first prompt to determine the second object.

According to some embodiments in the disclosure, obtaining the first prompt further includes: obtaining the first prompt based on the first image.

According to some embodiments in the disclosure, the method 800 further includes: in response to the first image indicating that the physical space includes a plurality of second objects associated with the first object, selecting a second object from the plurality of second objects.

According to some embodiments in the disclosure, the method 800 further includes: in response to determining that the first image of the physical space indicates that the first physical space includes the first object but not the second object, obtaining, by the robotic device, the first object.

According to some embodiments in the disclosure, the method 800 further includes: providing, to the user, a message for querying the user for a location of the second object in the physical space; and in response to receiving a response to the message from the user, obtaining, by the robotic device, the second object based on the response.

According to some embodiments in the disclosure, the first object is a book, and the method 800 further includes: receiving a request from the user to provide audio data associated with the book, identifying first text data in the book by the robotic device; and converting the first text data into first audio data.

According to some embodiments in the disclosure, the method 800 further includes: determining a position of the first text data in the book based on the request; and converting the first text data at the position into the first audio data.

According to some embodiments in the disclosure, the second object is a book, and the method 800 further includes: determining second text data associated with the first text data in the second object; and providing the second text data to the user.

According to some embodiments in the disclosure, the method 800 further includes: in response to receiving a response from the user for the second text data, determining an evaluation of the response.

### Example Apparatus and Apparatus

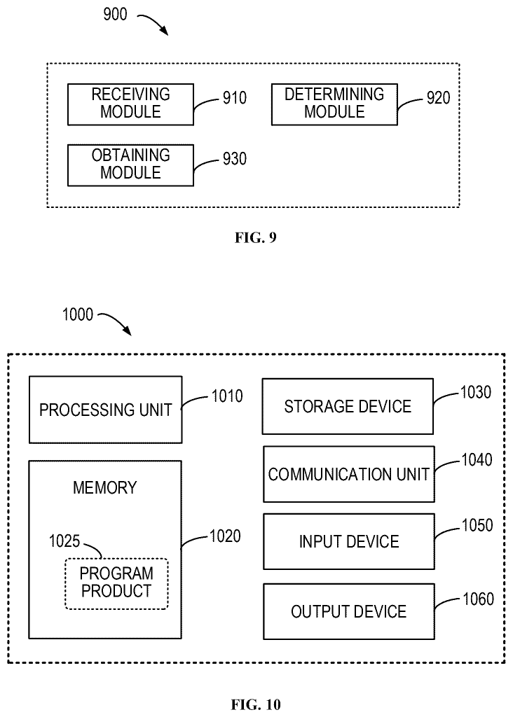

FIG. 9 shows a block diagram of an apparatus 900 for performing a user task according to some embodiments in the disclosure. The apparatus 900 includes: a receiving module 910, configured to receive a user task from a user, where the user task instructs the robotic device to obtain a first object; a determining module 920, configured to determine a second object associated with the first object; and an obtaining module 930, configured to, in response to determining that a first image of a physical space in which the robotic device is located indicates that the first physical space includes the first object and the second object, cause the robotic device to obtain the first object and the second object.

According to some embodiments in the disclosure, the determining module 920 is further configured to: obtain a first prompt based on the user task and the user information of the user, where the first prompt is configured to determine the second object; and receive a first response of a machine learning model for the first prompt to determine the second object.

According to some embodiments in the disclosure, the determining module 920 is further configured to: obtain the first prompt based on the first image.

According to some embodiments in the disclosure, the obtaining module 930 is further configured to: in response to the first image indicating that the physical space includes a plurality of second objects associated with the first object, select the second object from the plurality of second objects.

According to some embodiments in the disclosure, the obtaining module 930 is further configured to: in response to determining that the first image of the physical space indicates that the first physical space includes the first object but not the second object, cause the robotic device to obtain the first object.

According to some embodiments in the disclosure, the obtaining module 930 is further configured to: provide, to the user, a message for querying the user for a location of the second object in the physical space; and in response to receiving the response to the message from the user, cause the robotic device to obtain the second object based on the response.

According to some embodiments in the disclosure, the first object is a book, and the receiving module 910 is further configured to: receive a request from the user to provide audio data associated with the book in and identify first text data in the book by the robotic device; and convert the first text data into first audio data.

According to some embodiments in the disclosure, the receiving module 910 is further configured to: determine a position of the first text data in the book based on the request; and convert the first text data at the position into the first audio data.

According to some embodiments in the disclosure, the second object is a book, and the receiving module 910 is further configured to: determine second text data associated with the first text data in the second object; and provide the second text data to the user.

According to some embodiments in the disclosure, the receiving module 910 is further configured to: in response to receiving a response of the user for the second text data, determine an evaluation of the response.

FIG. 10 illustrates a block diagram of a device 1000 in which various embodiments in the disclosure may be implemented. It should be understood that the computing device 1000 shown in FIG. 10 is merely example and should not constitute any limitation on the functionality and scope of the embodiments described herein. The computing device 1000 shown in FIG. 10 may be configured to implement the method described above.

As shown in FIG. 10, the computing device 1000 is in the form of a general-purpose computing device. Components of the computing device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and may perform various processes according to programs stored in the memory 1020. In multiprocessor systems, multiple processing units execute computer-executable instructions in parallel to improve parallel processing capabilities of computing device 1000.

Computing device 1000 typically includes a plurality of computer storage media. Such media may be any available media accessible by the computing device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1030 may be a removable or non-removable medium and may include a machine-readable medium, such as a flash drive, magnetic disk, or any other medium, which may be used to store information and/or data (e.g., training data for training) and may be accessed within computing device 1000.

The computing device 1000 may further include additional removable/non-removable, volatile/non-volatile storage media. Although not shown in FIG. 10, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1020 may include a computer program product 1025 having one or more program modules configured to perform various methods or actions of various embodiments in the disclosure.

The communications unit 1040 implements communications with other computing devices over a communications medium. Additionally, the functionality of components of the computing device 1000 may be implemented in a single computing cluster or multiple computing machines, which may communicate over a communication connection. Thus, the computing device 1000 may operate in a networked environment using logical connections with one or more other servers, network personal computers (PCs), or another network node.

The input device 1050 may be one or more input devices such as a mouse, a keyboard, a trackball, or the like. The output device 1060 may be one or more output devices, such as a display, a speaker, a printer, or the like. Computing device 1000 may also communicate with one or more external devices (not shown) as needed, external devices such as storage devices, display devices, etc., communicate with one or more devices that enable a user to interact with computing device 1000, or communicate with any device (e.g., network card, modem, etc.) that enables computing device 1000 to communicate with one or more other computing devices. Such communication may be performed via an input/output (I/O) interface (not shown).

According to example embodiments in the disclosure, there is provided a computer-readable storage medium having computer-executable instructions stored thereon, where the computer-executable instructions are executed by a processor to implement the method described above. According to example embodiments in the disclosure, a computer program product is further provided, the computer program product being tangibly stored on a non-transitory computer-readable medium and including computer-executable instructions, the computer-executable instructions being executed by a processor to implement the method described above. According to example embodiments in the disclosure, there is provided a computer program product having stored thereon a computer program, which when executed by a processor, implements the method described above.

Aspects in the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible embodiments of systems, methods, and computer program products according to various embodiments in the disclosure. In this regard, each block in the flowchart or block diagram may represent a module, program segment, or portion of an instruction that includes one or more executable instructions for implementing the specified logical function. In some alternative embodiments, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various embodiments in the disclosure have been described above, which are example, not exhaustive, and are not limited to the embodiments disclosed. Many modifications and variations will be apparent to those of ordinary skill in the art without departing from the scope and spirit of the various embodiments illustrated. The selection of the terms used herein is intended to best explain the principles of the embodiments, practical applications, or improvements to techniques in the marketplace, or to enable others of ordinary skill in the art to understand the various embodiments disclosed herein.

1. A method for performing a user task, comprising:
receiving, by a robotic device, a user task from a user, the user task instructing the robotic device to obtain a first object;
determining a second object associated with the first object; and
obtaining, in response to determining that a first image of a physical space in which the robotic device is located indicates that the physical space comprises the first object and the second object, the first object and the second object by the robotic device.

2. The method of claim 1, wherein determining the second object comprises:
obtaining a first prompt based on the user task and user information of the user, the first prompt configured to determine the second object; and
receiving a first response of a machine learning model for the first prompt to determine the second object.

3. The method of claim 2, wherein obtaining the first prompt further comprises: obtaining the first prompt based on the first image.

4. The method of claim 2, further comprising: selecting, in response to the first image indicating that the physical space comprises a plurality of second objects associated with the first object, the second object from the plurality of second objects.

5. The method of claim 1, further comprising: obtaining, in response to determining that the first image of the physical space indicates that the physical space comprises the first object but not the second object, the first object by the robotic device.

6. The method of claim 5, further comprising:
providing, to the user, a message for querying the user for a location of the second object in the physical space; and
obtaining, in response to receiving a response to the message from the user, the second object by the robotic device based on the response.

7. The method of claim 1, wherein the first object is a book, and the method further comprises:
receiving, from the user, a request to provide audio data associated with the book, and identifying first text data in the book by the robotic device; and
converting the first text data into first audio data.

8. The method of claim 7, further comprising:
determining a position of the first text data in the book based on the request; and
converting the first text data at the location to the first audio data.

9. The method of claim 8, wherein the second object is a book, and the method further comprises:
determining second text data associated with the first text data in the second object; and
providing the second text data to the user.

10. The method of claim 9, further comprising: determining, in response to receiving a response to the second text data from the user, an evaluation of the response.

11. (canceled)

12. A robotic device, comprising:
at least one processing unit; and
at least one memory coupled to the at least one processing unit and storing instructions for execution by the at least one processing unit, the instructions, when executed by the at least one processing unit, causing the robotic device to perform acts for performing a user task comprising:
receiving, by the robotic device, a user task from a user, the user task instructing the robotic device to obtain a first object;
determining a second object associated with the first object; and
obtaining, in response to determining that a first image of a physical space in which the robotic device is located indicates that the physical space comprises the first object and the second object, the first object and the second object by the robotic device.

13-14. (canceled)

15. The robotic device of claim 12, wherein determining the second object comprises:
obtaining a first prompt based on the user task and user information of the user, the first prompt configured to determine the second object; and
receiving a first response of a machine learning model for the first prompt to determine the second object.

16. The robotic device of claim 15, wherein obtaining the first prompt further comprises: obtaining the first prompt based on the first image.

17. The robotic device of claim 15, the acts further comprising: selecting, in response to the first image indicating that the physical space comprises a plurality of second objects associated with the first object, the second object from the plurality of second objects.

18. The robotic device of claim 12, the acts further comprising: obtaining, in response to determining that the first image of the physical space indicates that the physical space comprises the first object but not the second object, the first object by the robotic device.

19. The robotic device of claim 18, the acts further comprising:
providing, to the user, a message for querying the user for a location of the second object in the physical space; and
obtaining, in response to receiving a response to the message from the user, the second object by the robotic device based on the response.

20. The robotic device of claim 12, wherein the first object is a book, and the acts further comprise:
receiving, from the user, a request to provide audio data associated with the book, and identifying first text data in the book by the robotic device; and
converting the first text data into first audio data.

21. The robotic device of claim 20, the acts further comprising:
determining a position of the first text data in the book based on the request; and
converting the first text data at the location to the first audio data.

22. The robotic device of claim 21, wherein the second object is a book, and the acts further comprise:
determining second text data associated with the first text data in the second object; and
providing the second text data to the user.

23. A non-transitory computer-readable storage medium having stored thereon a computer program which, when executed by a processor, causes the processor to implement acts for performing a user task comprising:
receiving, by a robotic device, a user task from a user, the user task instructing the robotic device to obtain a first object;
determining a second object associated with the first object; and
obtaining, in response to determining that a first image of a physical space in which the robotic device is located indicates that the physical space comprises the first object and the second object, the first object and the second object by the robotic device.
